(19) United States
(12) Patent Application Publication
(10) Pub. No.: US 2025/0250199 A1
(43) Pub. Date: Aug. 7, 2025

(54) Carbon-Sequestering Concrete Composition with Enhanced CO2 Absorbtion and Method of Manufacturing Thereof

(71) Applicant: Michael Lafave, Denvor, CO (US)

(72) Inventor: Michael Lafave, Denvor, CO (US)

(21) Appl. No.: 18/909,669

(22) Filed: Oct. 8, 2024

Related U.S. Application Data
(63) Continuation-in-part of application No. 18/814,312, filed on Aug. 23, 2024.
(63) Continuation of application No. PCT/US24/13913, filed on Feb. 1, 2024.

(51) Int. Cl. C04B 12/00; C04B 14/04; C04B 14/06; C04B 14/10; C04B 14/26; C04B 18/08; C04B 18/14; C04B 22/00; C04B 24/38; C04B 28/00; C04B 40/00; C04B 103/10; C04B 103/30; C04B 103/32; C04B 111/00

(52) U.S. Cl. CPC C04B 12/005; C04B 14/042; C04B 14/06; C04B 14/106; C04B 14/26; C04B 18/08; C04B 18/142; C04B 22/00863; C04B 24/38; C04B 28/006; C04B 40/0032; C04B 2103/10; C04B 2103/304; C04B 2103/32; C04B 2111/00017

(57) ABSTRACT

A carbon-sequestering concrete composition and method of production are disclosed. The composition comprises geopolymer binder components, aggregates, and alginate beads formed from brown algae powder through ionic gelation. The alginate beads significantly increase CO2 absorption surface area compared to algae powder, creating a matrix across the concrete surface that enhances long-term sequestration and improves durability. The beads interact synergistically with other concrete components, including geopolymers, fly ash, and ground granulated blast furnace slag, to enhance pozzolanic reactions and create additional sites for carbon dioxide capture. The alginate beads also facilitate the dissolution of minerals like olivine, further enhancing carbon capture. The composition demonstrates superior carbon sequestration capabilities, enabling sustained CO2 absorption throughout its service life. The method includes forming alginate beads, incorporating them into the concrete mixture, and allowing for initial hardening and drying processes that promote carbon dioxide absorption directly from the air.

### CROSS REFERENCE TO RELATED APPLICATIONS

This application claims the benefit of and incorporates by reference in its entirety U.S. Provisional Patent Application No. 63/469,108, filed May 26, 2023 which is incorporated herein by reference in its entirety. This application also claims the benefit of, is a continuation-in-part of, and incorporates by reference in its entirety U.S. patent application Ser. No. 18/722,678, filed on Jun. 21, 2024, and U.S. patent application Ser. No. 18/814,312 filed on Aug. 23, 2024. This application also claims the benefit of and incorporates by reference in its entirety International Patent Application No. PCT/US24/13913, filed Feb. 1, 2024.

### FIELD OF THE INVENTION

The present invention relates to the field of sustainable construction materials, specifically to carbon-sequestering concrete compositions and methods for their production.

### BACKGROUND OF THE INVENTION

Concrete is one of the most widely used construction materials globally, with over 4 billion metric tons produced annually.

However, conventional Portland cement concrete production is a significant contributor to global carbon dioxide emissions, accounting for 7-8% of all CO2 emissions worldwide. This represents an immense environmental burden, generating over 2 gigatons of carbon dioxide per year during cement production alone.

Recent efforts to mitigate the carbon footprint of concrete have explored various approaches, including the incorporation of seawater and algae into concrete mixes to enable CO2 sequestration.

However, these existing methods have achieved only modest and inconsistent levels of CO2 absorption that pale in comparison to the scale of emissions from concrete production.

One such approach is described in Korean Patent No. 102079643 B1 to Lee et al. (“LEE”), which discloses a carbon dioxide-absorbing marine concrete composition made by mixing blast furnace slag, fly ash, metakaolin, sodium silicate, and dried algae powder. While this composition attempts to address the environmental impact of concrete production, it suffers from several significant limitations.

The use of algae powder alone in the manner disclosed by LEE fails to fully leverage the carbon sequestration potential of marine algae, as it does not provide optimal surface area for CO2 absorption or create the necessary conditions for long-term carbon mineralization. Furthermore, simply mixing algae powder into concrete does not facilitate the formation of a matrix across the concrete surface that could enhance long-term sequestration and improve durability. There is a need for an innovative approach that can dramatically increase the CO2 absorption capacity of concrete, create synergistic interactions with other concrete components, and provide a mechanism for moisture retention to facilitate greater direct air capture of CO2. Such an approach would overcome the limitations of current algae-based concrete technologies and offer superior CO2 sequestration capabilities, enhanced durability, and improved overall performance.

The need for carbon-capturing concrete has become increasingly urgent as the construction industry seeks to reduce its significant carbon footprint. To incentivize the adoption of such environmentally beneficial technologies, various tax credits and incentives have been established. Section 45Q of the Internal Revenue Code provides tax credits for carbon oxide sequestration, which can result in substantial savings for concrete producers utilizing this technology. Additionally, the Investment Tax Credit offers up to 30% credit on capital investments in carbon-capturing technologies. Other applicable incentives include R&D tax credits, Production Tax Credits, and various federal and state tax incentives designed to promote sustainable construction practices. These financial incentives not only make the adoption of carbon-sequestering concrete more economically viable but also align with broader policy goals of reducing greenhouse gas emissions and promoting sustainable development in the construction industry.

These limitations result in a concrete composition that, while attempting to address environmental concerns, falls short of achieving significant and long-lasting carbon sequestration. The present invention seeks to overcome these limitations by providing a novel carbon-absorbing concrete composition and method of production that offers superior CO2 sequestration capabilities, enhanced durability, and improved overall performance compared to existing technologies.

### SUMMARY OF THE INVENTION

The present invention relates to a carbon-sequestering concrete composition and method of production that addresses the limitations of previous approaches to reducing the carbon footprint of concrete.

At the core of the preferred embodiment is the utilization of brown algae species, particularly “Macrocystis pyrifera”, which are transformed into alginate beads through a process called ionic gelation. These alginate beads dramatically increase the surface area available for CO2 absorption, forming a matrix across the concrete surface that enhances long-term sequestration and improves durability.

The alginate beads are created through ionic gelation using brown algae powder. This process involves mixing the algae powder with water to create an alginate solution, which is then introduced dropwise into a bath containing calcium ions. As the droplets come into contact with the calcium ions, they undergo rapid gelation, forming stable, three-dimensional network structures with a high surface area, ideal for CO2 absorption and moisture retention in concrete.

The preferred embodiment leverages the synergistic interactions between the alginate beads and other concrete components, including geopolymers, fly ash, and ground granulated blast furnace slag (GGBFS). These interactions enhance pozzolanic reactions, create additional sites for carbon dioxide capture, and prolong the period of CO2 absorption.

The alginate beads play a crucial role in moisture retention in the context of the preferred embodiment, creating localized high-humidity environments within the concrete that facilitate greater direct air capture of CO2. This moisture retention is essential for the carbon sequestration process, as it provides a medium for CO2 to dissolve and react with calcium ions to form stable calcium carbonate.

The preferred embodiment also addresses the formation of bicarbonate (HCO3-) ions in the presence of moisture from alginate beads, which is crucial for the carbon sequestration mechanism of the concrete. This process contributes to the concrete's ability to sequester CO2 not only during the initial curing phase but also throughout its service life.

Furthermore, the alginate beads contribute to the self-healing of micro-cracks in the concrete, extending its lifespan and durability. This self-healing property maintains the concrete's ability to absorb CO2 over a longer period by preserving the integrity of the concrete structure.

In summary, the preferred embodiment provides a concrete composition with superior carbon sequestration capabilities, enabling sustained CO2 absorption throughout its service life. It addresses the limitations of previous approaches and represents a significant advancement in sustainable construction materials.

### BRIEF DESCRIPTION OF THE FIGURES

FIG. 1 depicts the usage of an embodiment of the invention in association with a sidewalk.

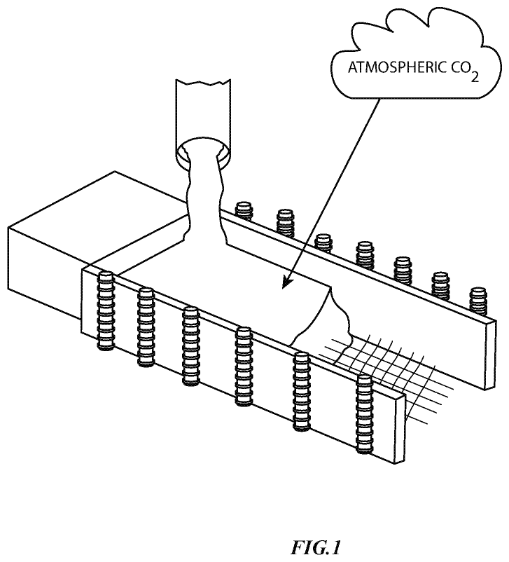

FIG. 2 depicts the usage of an embodiment of the invention in association with a pillar associated with a typical construction project.

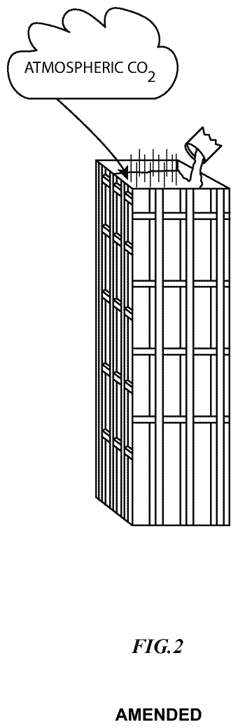

### DETAILED DESCRIPTION

The preferred embodiment comprises a carbon-sequestering concrete and the associated methods of manufacture, addressing the limitations of previous methods and significantly enhancing CO2 absorption capabilities.

At the core of this embodiment is the utilization of brown algae species, particularly “Macrocystis pyrifera”, which are transformed into alginate beads through a process called ionic gelation. These alginate beads dramatically increase the surface area available for CO2 absorption, forming a matrix across the concrete surface that enhances long-term sequestration and improves durability. The alginate beads in the preferred embodiment are created through a process called ionic gelation using brown algae powder, particularly from species “Macrocystis pyrifera”. This process is critical for enhancing CO2 absorption in the concrete mixture.

The brown algae species “Macrocystis pyrifera” was chosen for creating alginate beads in the preferred embodiment due to its superior carbon sequestration capabilities. This species has evolved robust cell walls with concentrated salts and carbon-binding structures optimized for ocean conditions, making it significantly more effective for CO2 absorption compared to red and green algae species. The alginate extracted from Macrocystis pyrifera is particularly rich in carboxyl groups, which are crucial for the ionic gelation process used to form the beads. When mixed with water and introduced dropwise into a calcium ion bath, the alginate from Macrocystis pyrifera forms stable, three-dimensional network structures with a high surface area, ideal for CO2 absorption and moisture retention in concrete. In alternative embodiments, other brown algae species may serve as a substitute, including but not limited to Laminaria, Ascophyllum, Sargassum, and Fucus species. These alternative species also possess similar cell wall structures and carbon-binding capabilities, although Macrocystis pyrifera remains the preferred choice due to its particularly high alginate content and optimal gelation properties for concrete applications.

To form the alginate beads, the brown algae powder is first mixed with water to create an alginate solution. This solution contains the alginate polymers naturally present in the cell walls of brown algae, which are rich in carboxyl groups.

The alginate solution in an embodiment is then introduced dropwise into a bath containing divalent cations, typically calcium ions. As the alginate droplets come into contact with the calcium ions, they undergo a rapid gelation process. The calcium ions crosslink the alginate polymers, forming a stable, three-dimensional network structure. This ionic gelation process results in the formation of spherical alginate beads with a significantly increased surface area compared to the original algae powder. The beads have a porous structure that allows for efficient CO2 absorption and retention of moisture. The ionic gelation process for forming alginate beads in an embodiment begins with mixing brown algae powder, particularly from species like “Macrocystis pyrifera”, with water to create an alginate solution. This solution contains the alginate polymers naturally present in the cell walls of brown algae, which are rich in carboxyl groups. The alginate solution is then introduced dropwise into a bath containing divalent cations, typically calcium ions. As the alginate droplets come into contact with the calcium ions, they undergo a rapid gelation process. The calcium ions crosslink the alginate polymers, forming a stable, three-dimensional network structure. This process results in the formation of spherical alginate beads with a significantly increased surface area compared to the original algae powder. The beads have a porous structure that allows for efficient CO2 absorption and retention of moisture. The size and density of the alginate beads can be controlled by adjusting various parameters during the gelation process, such as the concentration of the alginate solution, the type and concentration of the crosslinking ions, and the droplet size. This allows for optimization of the beads' properties to suit the specific requirements of the concrete mixture. Once formed, the alginate beads are collected and may undergo further processing, such as washing to remove excess ions and drying to a desired moisture content. The resulting beads are then ready to be incorporated into the concrete mixture, where they will play a crucial role in enhancing CO2 sequestration and improving the overall performance of the concrete in accordance with an embodiment of the invention.

The size and density of the alginate beads can be controlled by adjusting various parameters during the gelation process, such as the concentration of the alginate solution, the type and concentration of the crosslinking ions, and the droplet size. This allows for optimization of the beads' properties to suit the specific requirements of the concrete mixture.

Once formed, the alginate beads are collected and may undergo further processing, such as washing to remove excess ions and drying to a desired moisture content. The resulting beads are then ready to be incorporated into the concrete mixture, where they will play a crucial role in enhancing CO2 sequestration and improving the overall performance of the concrete.

The formation of these alginate beads through ionic gelation is a key innovation that sets the preferred embodiment of the invention apart from previous approaches that simply mixed algae powder into concrete. The beads provide a matrix across the surface of the concrete, dramatically enhancing long-term sequestration and improving the concrete's durability.

The alginate beads formed from brown algae powder significantly increase the CO2 absorption surface area compared to simply using algae powder in concrete. This enhancement in surface area is achieved through the ionic gelation process, which creates a porous, three-dimensional structure within each bead.

When algae powder is directly mixed into concrete in accordance with the preferred embodiment, it remains as discrete particles with limited surface area exposed for CO2 interaction. In contrast, the alginate beads form a matrix across the surface of the concrete, dramatically increasing the total surface area available for carbon dioxide absorption.

The ionic gelation process creates a network of interconnected pores within each alginate bead. This porous structure allows CO2 molecules to penetrate deep into the bead, rather than just interacting with the outer surface. As a result, the effective surface area for CO2 absorption is multiplied many times over compared to solid algae powder particles in accordance with the preferred embodiment.

Furthermore, the alginate beads absorb and retain moisture, creating localized high-humidity environments within the concrete matrix. This moisture retention further enhances CO2 absorption, as the carbonation process reacts more readily in the presence of water. The combination of increased surface area and moisture retention allows for significantly more efficient CO2 capture and conversion to stable carbonate compounds.

The size and density of the alginate beads can be controlled during the gelation process in accordance with various embodiments, allowing for optimization of the surface area to volume ratio. By adjusting parameters such as alginate concentration, crosslinking ion type and concentration, and droplet size, the beads can be tailored to maximize their CO2 absorption capacity.

Additionally, the alginate beads create a more uniform distribution of CO2 absorption sites throughout the concrete matrix compared to algae powder. This even distribution ensures that the carbon sequestration potential is maximized across the entire concrete structure, rather than being limited to localized areas where algae powder particles might cluster.

The cumulative effect of these factors in accordance with the preferred embodiment-increased surface area, porous structure, moisture retention, and uniform distribution-results in CO2 absorption capabilities that are orders of magnitude greater than what can be achieved with simple algae powder incorporation associated with other attempts. This dramatic enhancement in carbon sequestration efficiency is a critical innovation of the preferred embodiment of the invention, enabling concrete structures to serve as highly effective carbon sinks throughout their service life.

The preferred embodiment leverages the synergistic interactions between the alginate beads and other concrete components, including geopolymers, fly ash, and ground granulated blast furnace slag (GGBFS).

These interactions enhance pozzolanic reactions, create additional sites for carbon dioxide capture, and prolong the period of CO2 absorption. The alginate beads also play a crucial role in moisture retention, creating localized high-humidity environments within the concrete that facilitate greater direct air capture of CO2.

The preferred embodiment enhances pozzolanic reactions through the synergistic interaction between alginate beads and various components of the concrete mix, particularly fly ash and metakaolin.

Pozzolanic reactions occur when siliceous or aluminosiliceous materials react with calcium hydroxide in the presence of water to form compounds with cementitious properties. In the context of this invention, the alginate beads create localized high-humidity environments within the concrete matrix, which facilitates these reactions. The increased moisture content provided by the beads promotes the dissolution of silica and alumina from the pozzolanic materials, allowing them to react more readily with calcium hydroxide produced during the hydration of cement or geopolymer precursors. This enhanced reactivity leads to the formation of additional calcium silicate hydrate (C—S—H) and calcium aluminate hydrate (C-A-H) gels, which contribute to the concrete's strength and durability. Furthermore, the pozzolanic reactions consume calcium hydroxide, reducing the concrete's susceptibility to chemical attacks and improving its long-term performance. The increased pozzolanic activity also creates more sites for carbon dioxide capture within the concrete composition, as the newly formed C—S—H and C-A-H gels provide additional surface area for CO2 absorption and carbonation.

The preferred embodiment creates additional sites for carbon dioxide capture through several mechanisms. The alginate beads formed from brown algae powder increase the surface area available for CO2 absorption, creating a matrix across the concrete surface that enhances long-term sequestration. This matrix structure provides numerous additional sites for CO2 to interact with and be captured by the concrete. Furthermore, the synergistic interactions between the alginate beads and other concrete components, such as fly ash and ground granulated blast furnace slag (GGBFS), lead to enhanced pozzolanic reactions in association with the preferred embodiment.

These reactions create more sites in the concrete composition specifically for capturing carbon dioxide. The increased pozzolanic activity results in the formation of additional calcium silicate hydrate (C—S—H) and calcium aluminate hydrate (C-A-H) gels, which provide extra surface area for CO2 absorption and carbonation. The alginate beads also interact positively with other additives in the mix, such as magnesium carbonate and olivine (Mg2SiO4).

The alginate beads in the preferred embodiment interact synergistically with additives like magnesium carbonate and olivine (Mg2SiO4) to enhance the concrete's CO2 sequestration capabilities. The moisture retention properties of the alginate beads play a crucial role in facilitating these interactions.

For magnesium carbonate, the localized high-humidity environments created by the alginate beads promote its gradual dissolution within the concrete matrix. This dissolution process releases magnesium ions, which can then react with dissolved CO2 to form stable magnesium carbonate compounds, effectively capturing and storing atmospheric carbon dioxide.

In the case of olivine (Mg2SiO4), the humidity retained by the alginate beads creates conditions favorable for its dissolution in accordance with the preferred embodiment. As the olivine dissolves, it releases magnesium ions into the concrete matrix. These magnesium ions can then interact with the alginate structure, enhancing the formation of magnesium carbonates. This process not only contributes to additional CO2 sequestration but also improves the overall strength and durability of the concrete.

The alginate beads create “localized high-humidity environments” within the concrete through their unique moisture absorption and retention properties. When incorporated into the concrete mixture, these beads absorb and hold water, acting as microscopic reservoirs distributed throughout the concrete matrix.

In accordance with the preferred embodiment, as the concrete cures and ages, the alginate beads continue to retain this moisture, creating small pockets of high humidity surrounding each bead. These localized high-humidity environments are crucial for facilitating CO2 absorption, as the carbonation process reacts more readily in the presence of water. The retained moisture provides a medium for atmospheric CO2 to dissolve, forming carbonic acid which then interacts with calcium ions to produce stable calcium carbonate. This process of CO2 absorption and carbonate formation is significantly enhanced by the consistent availability of moisture provided by the alginate beads, allowing for continuous carbon sequestration throughout the concrete's service life. Furthermore, these high-humidity microenvironments promote the gradual dissolution of other additives like magnesium carbonate and olivine, further enhancing the concrete's overall CO2 absorption capacity.

The continuous moisture provision by the alginate beads ensures that these reactions can occur over an extended period, prolonging the concrete's carbon capture capabilities. As atmospheric CO2 dissolves in the water retained by the beads, it forms carbonic acid, which then reacts with the magnesium ions released from both magnesium carbonate and olivine to produce stable carbonate compounds. These interactions between the alginate beads and additives like magnesium carbonate and olivine create a self-sustaining cycle of CO2 absorption and mineralization within the concrete. The process continues throughout the concrete's service life, significantly enhancing its long-term carbon sequestration potential compared to traditional concrete compositions.

The preferred embodiment prolongs the period of CO2 absorption through several innovative mechanisms. The alginate beads formed from brown algae powder play a crucial role in extending the carbon sequestration capabilities of the concrete over time. These beads absorb and retain moisture, creating localized high-humidity environments within the concrete matrix that facilitate ongoing CO2 absorption.

The synergistic interactions between the alginate beads and other concrete components, such as ground granulated blast furnace slag (GGBFS), increase both the hydration and carbonation processes. This effectively extends the duration during which the concrete can actively absorb carbon dioxide from the atmosphere.

Furthermore, the alginate beads enhance the CO2 sequestration capabilities of other additives in the mix, such as magnesium carbonate and olivine (Mg2SiO4). The humidity retained by the beads creates conditions that promote the gradual dissolution of these minerals, leading to sustained carbon capture over an extended period. The continuous process of CO2 absorption is supported by the ongoing formation of carbonate compounds within the concrete matrix.

The alginate beads facilitate the dissolution of minerals including olivine (Mg2SiO4) to enhance carbon capture through several mechanisms. The beads absorb and retain moisture, creating localized high-humidity environments within the concrete matrix. This increased moisture content promotes the gradual dissolution of olivine, releasing magnesium ions into the surrounding concrete. The humidity in the alginate beads creates these localized high moisture environments, which are crucial for facilitating olivine dissolution. As the olivine dissolves, the released magnesium ions interact with the alginate structure, enhancing the formation of magnesium carbonates. This process not only contributes to additional CO2 sequestration but also improves the overall strength and durability of the concrete. The continuous moisture provision by the alginate beads ensures that these reactions can occur over an extended period, prolonging the concrete's carbon capture capabilities. Furthermore, the beads provide additional surface area for basalt dissolution, which leads to further carbon capture. This synergistic interaction between the alginate beads and olivine creates a self-sustaining cycle of CO2 absorption and mineralization within the concrete, significantly enhancing its long-term carbon sequestration potential compared to traditional concrete compositions.

As atmospheric CO2 dissolves in the water retained by the alginate beads, it forms carbonic acid, which then reacts with calcium ions to produce stable calcium carbonate. This cycle of absorption and mineralization continues throughout the concrete's service life, significantly prolonging its CO2 sequestration capabilities.

Additionally, the formation of stable calcium carbonate contributes to the self-healing of micro-cracks in the concrete. This self-healing property not only extends the overall lifespan of the concrete but also maintains its ability to absorb CO2 over a longer period by preserving the integrity of the concrete structure. The alginate beads also contribute to the self-healing of micro-cracks in the concrete through several mechanisms. As the concrete cures and ages, the alginate beads continue to absorb and retain moisture, creating localized high-humidity environments within the concrete matrix. When micro-cracks form, these moist environments facilitate the ongoing formation of carbonate compounds. As atmospheric CO2 dissolves in the water retained by the alginate beads, it forms carbonic acid, which then reacts with calcium ions to produce stable calcium carbonate. This calcium carbonate precipitates within the micro-cracks, gradually filling them and restoring the concrete's integrity. The continuous nature of this process, enabled by the moisture-retaining properties of the alginate beads, allows for ongoing self-healing throughout the concrete's service life. Additionally, the alginate beads' ability to enhance pozzolanic reactions and create additional sites for carbon dioxide capture contributes to the formation of supplementary binding materials that can further aid in crack repair. This self-healing property not only extends the overall lifespan of the concrete but also maintains its ability to absorb CO2 over a longer period by preserving the integrity of the concrete structure.

By incorporating these innovative features, the preferred embodiment addresses the limitations of previous approaches and provides a concrete composition with superior long-term carbon sequestration capabilities, enabling sustained CO2 absorption throughout its service life.

The humidity retained by the alginate beads creates localized high moisture environments that facilitate the dissolution of these minerals, leading to further carbon capture opportunities. This process increases the overall number of sites available for CO2 sequestration within the concrete matrix. Lastly, the moisture retention properties of the alginate beads create conditions favorable for the ongoing formation of carbonate compounds throughout the concrete.

As CO2 dissolves in the water absorbed by the beads, it forms carbonic acid, which then interacts with calcium ions to form stable calcium carbonate. This continuous process effectively creates new sites for carbon dioxide capture as the concrete ages, prolonging its CO2 sequestration capabilities over time.

This innovative concrete composition not only reduces the carbon footprint associated with production but also actively removes CO2 from the atmosphere throughout its service life. The carbon capture process in the preferred embodiment occurs strongly over the initial approximately 60 days due to the rapid initial reactions between the alginate beads and atmospheric CO2, but continues on a smaller scale for many years thereafter.

This prolonged sequestration is enabled by several key mechanisms:

During the initial curing period, the alginate beads formed through ionic gelation provide a large surface area for CO2 absorption, allowing for rapid carbonation reactions. The beads absorb and retain moisture, creating localized high-humidity environments that facilitate the dissolution of CO2 and its reaction with calcium ions to form stable calcium carbonate.

As the concrete continues to age, the synergistic interactions between the alginate beads and other components of the mix, such as ground granulated blast furnace slag (GGBFS) and fly ash, sustain the carbon capture process. These interactions lead to ongoing pozzolanic reactions and the creation of additional sites for CO2 absorption, albeit at a slower rate than during the initial curing period.

The moisture retention properties of the alginate beads play a crucial role in maintaining conditions favorable for long-term CO2 sequestration. Even as the concrete ages, the beads continue to absorb and retain water from the environment, providing a medium for CO2 to dissolve and react with available calcium ions.

Furthermore, the formation of stable calcium carbonate through the interaction of dissolved CO2 with calcium ions contributes to the self-healing of micro-cracks in the concrete. This self-healing process not only extends the lifespan of the concrete but also maintains pathways for continued CO2 absorption over many years.

The gradual dissolution of minerals such as magnesium carbonate and olivine, facilitated by the moisture retained in the alginate beads, provides a slow but steady source of reactive components for ongoing CO2 sequestration. This process continues at a reduced rate long after the initial curing period, allowing the concrete to capture carbon dioxide from the atmosphere throughout its service life.

The formation of stable calcium carbonate through the interaction of dissolved CO2 with calcium ions in the alginate beads contributes to the self-healing of micro-cracks, further extending the concrete's lifespan and durability. By addressing the limitations of previous approaches, this invention represents a significant advancement in sustainable construction materials, offering superior carbon sequestration capabilities, enhanced durability, and improved overall performance.

The preferred embodiment of the present invention addresses the limitations of previous approaches by utilizing brown algae species, particularly “Macrocystis pyrifera”, which have evolved robust cell walls with concentrated salts and carbon-binding structures optimized for ocean conditions. This makes them significantly more effective for CO2 absorption compared to red and green algae species. The use of brown algae provides a more efficient and targeted approach to carbon sequestration in concrete, leveraging their natural adaptations to marine environments.

A critical innovation in the preferred embodiment is the formation of alginate beads using brown algae powder through a process called ionic gelation. This process dramatically increases the surface area available for CO2 absorption, enhancing it by orders of magnitude compared to simply mixing algae powder into the concrete. The alginate beads form a matrix across the surface of the concrete, which significantly enhances long-term sequestration and improves the concrete's durability. This matrix structure allows for more uniform and efficient carbon dioxide capture throughout the concrete, leading to superior performance over extended periods.

The formation of alginate beads offers several key advantages over traditional methods. The increased surface area provided by the beads allows for more efficient CO2 absorption, while also promoting the formation of more stable calcium carbonate. This stability is crucial for long-term carbon sequestration, ensuring that the captured CO2 remains locked within the concrete structure for extended periods. Additionally, the uniform distribution of alginate beads throughout the concrete mix ensures that the CO2 capture potential is evenly spread, maximizing the overall sequestration capacity of the concrete.

The alginate beads in the preferred embodiment interact synergistically with other components of the concrete mix, including geopolymers, fly ash, and ground granulated blast furnace slag (GGBFS). These interactions enhance the overall performance and carbon sequestration capabilities of the concrete. For instance, the presence of alginate beads leads to enhanced pozzolanic reactions with fly ash, creating more sites within the concrete composition for capturing carbon dioxide. This increased reactivity not only improves the concrete's strength but also its ability to absorb CO2 over time.

In the case of GGBFS, the alginate beads increase both the hydration and carbonation processes, effectively prolonging the period during which the concrete can absorb carbon dioxide. This extended absorption window is crucial for maximizing the total amount of CO2 sequestered over the lifetime of the concrete structure. Similarly, the interaction between alginate beads and metakaolin results in increased pozzolanic activity, further enhancing the concrete's performance and carbon capture capabilities.

The alginate beads also enhance the CO2 sequestration capabilities of other additives in the mix, such as magnesium carbonate and olivine (Mg2SiO4). The beads create localized high-moisture environments that facilitate the dissolution of these minerals, leading to increased formation of carbonate compounds. This synergistic effect amplifies the overall carbon sequestration potential of the concrete, making it significantly more effective at reducing atmospheric CO2 levels compared to traditional concrete formulations.

One of the most crucial roles played by the alginate beads in the preferred embodiment is in moisture retention, which is essential for the carbon sequestration process. The beads absorb and retain water, creating localized high-humidity environments within the concrete matrix. This increased moisture content is vital for facilitating greater direct air capture (DAC) of CO2, as the carbonation process reacts more readily in the presence of water. The absorbed water acts as a medium in which CO2 can dissolve, forming carbonic acid (H2CO3) and initiating a series of chemical reactions that lead to carbon sequestration.

The presence of moisture within the alginate beads creates conditions favorable for the formation of bicarbonate (HCO3-) ions. This process is fundamental to the sequestration of various compounds within the concrete matrix. As CO2 dissolves and forms carbonic acid, it interacts with the calcium ions present within the alginate beads. This interaction leads to the formation of stable calcium carbonate, effectively locking the captured CO2 into the concrete structure. This process not only increases the overall CO2 uptake but also contributes to the self-healing of micro-cracks in the concrete, further extending its lifespan and durability.

The formation of bicarbonate (HCO3-) ions in the presence of moisture from alginate beads is a crucial process in the carbon sequestration mechanism of the concrete. The alginate beads, which are rich in carboxyl groups, absorb and retain water, creating localized high-humidity environments within the concrete matrix. As atmospheric CO2 dissolves in this water, it forms carbonic acid (H2CO3). In the presence of moisture, the carboxyl groups in the alginate react with this carbonic acid, leading to the formation of bicarbonate (HCO3-) ions.

This process is critical in accordance with the preferred embodiment because the bicarbonate ions serve as an intermediate step in the overall carbon mineralization process. The bicarbonate ions can further react with calcium ions within the alginate beads or from other sources in the concrete to form stable calcium carbonate (CaCO3). This reaction sequence effectively locks in the absorbed CO2, converting it from a gaseous form to a solid, stable mineral form within the concrete structure. The continuous moisture provision by the alginate beads ensures that this bicarbonate formation process can occur over an extended period, prolonging the concrete's carbon capture capabilities. This ongoing process contributes to the concrete's ability to sequester CO2 not only during the initial curing phase but also throughout its service life, albeit at a slower rate in later stages.

An embodiment of the present invention comprises a carbon-sequestering concrete composition with specific components and their respective percentages by mass. Alternative embodiments deviate slightly from the specific percentages by mass presented in the foregoing.

The composition includes Fly Ash (Class F) at 25%, which serves as the primary binder and significantly reduces CO₂ emissions compared to traditional cement. This component allows for increased CO₂-reactive materials in the mixture, enhancing the overall carbon sequestration potential of the concrete.

Ground Granulated Blast Furnace Slag (GGBFS) constitutes 20% of the mixture. This component enhances the strength and durability of the concrete while acting as a supplementary binder. The inclusion of GGBFS contributes to the reduction of the carbon footprint associated with concrete production by partially replacing traditional cement.

Metakaolin, comprising 5% of the mixture, improves early strength and reduces permeability of the concrete. This component allows room for more CO₂ capture materials, further enhancing the carbon sequestration capabilities of the concrete. The inclusion of metakaolin also contributes to the overall sustainability of the mixture by reducing the need for energy-intensive cement production.

Recycled Aggregates make up 20% of the composition, while Natural Aggregates constitute 15%. The use of recycled aggregates significantly reduces the environmental impact of the concrete production process by minimizing the need for new raw materials extraction. Natural aggregates provide the necessary mechanical strength to the concrete. The balance between recycled and natural aggregates is carefully optimized to maintain the structural integrity of the concrete while maximizing its sustainability.

Silica Fume, at 2% of the mixture, fills micro-pores and enhances the strength and durability of the concrete. This component improves the overall pore structure of the concrete, which is crucial for both strength development and carbon sequestration potential. The fine particles of silica fume react with calcium hydroxide produced during cement hydration, forming additional calcium silicate hydrate (C—S—H) gel, which enhances the concrete's properties.

Sodium Hydroxide (NaOH) and Sodium Silicate (Na₂SiO₃) serve as activators for the geopolymerization process, constituting 1.5% and 2.5% of the mixture respectively. These components are essential for activating the aluminosilicate materials in the mixture, particularly the fly ash and GGBFS. The careful balance of these activators ensures optimal reaction efficiency while minimizing environmental impact.

Algae Biomass, used for creating alginate beads, makes up 2% of the mixture. This component is crucial for maximizing CO₂ sequestration potential through the formation of alginate beads and direct air capture. The algae biomass is transformed into alginate beads through a process called ionic gelation, which dramatically increases the surface area available for CO₂ absorption.

Calcium Carbonate (CaCO₃) and Magnesium Carbonate (MgCO₃) each constitute 2% of the mixture. These components enhance carbonation during curing and beyond, improving overall CO₂ capture. They react with CO₂ to form stable carbonate compounds, effectively sequestering carbon within the concrete structure.

Silica from Algae, comprising 1% of the mixture, serves as a sustainable silica source that improves strength with minimal environmental impact. This component contributes to the overall sustainability of the concrete mixture while enhancing its mechanical properties.

Magnesium Silicate and Olivine (finely ground) each make up 1% of the mixture. These components enhance CO₂ sequestration through mineral carbonation. The fine grinding of olivine increases its surface area, making it more reactive and efficient in capturing CO₂. These materials react with atmospheric CO₂ to form stable carbonate minerals, effectively locking away carbon for long periods.

Basalt Rock Dust, constituting 1% of the mixture, provides trace minerals and enhances CO₂ uptake through mineral carbonation. This component contributes to the overall carbon sequestration potential of the concrete while also improving its mechanical properties.

Biochar (Activated) makes up 1% of the mixture. This component sequesters carbon and improves internal curing of the concrete. Biochar's porous structure allows it to absorb and retain CO₂, contributing significantly to the overall carbon sequestration capabilities of the concrete.

Alginate Beads, maximized at 1.5% of the mixture, play a crucial role in enhancing CO₂ capture. These beads, formed through ionic gelation of brown algae powder, dramatically increase the surface area available for CO₂ absorption. They form a matrix across the concrete surface, significantly enhancing long-term sequestration and improving durability.

Carbonation Accelerators (C—S—H Seeds) constitute 1.5% of the mixture. These accelerate strength gain and CO₂ uptake during curing. The C—S—H seeds provide nucleation sites for the formation of additional calcium silicate hydrate gel, which not only enhances the concrete's strength but also increases its capacity to absorb CO₂.

Water, making up 1% of the mixture, is necessary for workability and chemical reactions. The water content is carefully controlled to ensure optimal hydration of cementitious materials and proper workability of the concrete mix, while also facilitating the various chemical reactions involved in CO₂ sequestration.

This embodiment of the carbon-sequestering concrete composition demonstrates superior carbon sequestration capabilities compared to conventional concrete. For every 1,000 tons of concrete produced, this embodiment emits 81.4 tons of CO₂ but sequesters 91.25 tons of CO₂, resulting in a net sequestration of 9.85 tons of CO₂. This represents a total reduction of 909.85 tons of CO₂ per 1,000 tons produced, or a 101.1% reduction compared to conventional concrete.

The CO₂ sequestration in this embodiment occurs through several mechanisms, including biochar absorption, algae biomass uptake, carbonates reaction, mineral carbonation, alginate bead absorption, and CO₂ absorption during curing. The total CO₂ sequestered amounts to 91,250 kg (91.25 tonnes) per 1,000 tons of concrete produced.

The carbon-sequestering concrete composition described in this embodiment demonstrates remarkable carbon sequestration capabilities that significantly outperform conventional concrete. For every 1,000 tons of concrete produced, this innovative composition achieves a net carbon sequestration of 9.85 tons of CO₂, in stark contrast to conventional concrete which emits approximately 900 tons of CO₂ for the same amount produced. This results in a total reduction of 909.85 tons of CO₂ per 1,000 tons produced, representing a 101.1% reduction compared to conventional concrete.

The superior carbon sequestration performance of this concrete composition is achieved through a combination of reduced emissions during production and active carbon capture mechanisms. While the embodiment emits 81.4 tons of CO₂ during production, it sequesters 91.25 tons of CO₂, resulting in the net negative carbon footprint. This remarkable feat is accomplished through several key mechanisms that work synergistically to capture and store carbon dioxide.

The CO₂ sequestration in this embodiment occurs through several primary mechanisms, including the following: Biochar absorption, which accounts for 29,333 kg of CO₂ sequestered. The activated biochar in the mixture acts as a highly effective carbon sink due to its porous structure and high surface area. Algae Biomass uptake, responsible for sequestering 36,667 kg of CO₂. The algae biomass, particularly when transformed into alginate beads, provides a substantial contribution to the overall carbon capture capacity of the concrete. Carbonates Reaction, which sequesters 2,000 kg of CO₂. This involves the reaction of CO₂ with calcium and magnesium carbonates present in the mixture, forming stable carbonate compounds. Mineral Carbonation, accounting for 2,500 kg of CO₂ sequestered. This process involves the reaction of CO₂ with minerals such as magnesium silicate and olivine to form stable carbonate minerals. Alginate Beads, which directly capture 750 kg of CO₂ but also play a crucial role in enhancing the capture efficiency of other materials. The alginate beads, formed through ionic gelation of brown algae powder, create a matrix across the concrete surface that significantly increases the surface area available for CO₂ absorption. CO₂ absorbed during curing, which accounts for 20,000 kg of the total CO₂ sequestered. This substantial amount is captured during the initial setting and hardening phase of the concrete.

These mechanisms in an embodiment collectively result in a total CO₂ sequestration of 91,250 kg (91.25 tonnes) per 1,000 tons of concrete produced. The synergistic interactions between the various components, particularly the alginate beads and other concrete constituents like geopolymers, fly ash, and ground granulated blast furnace slag (GGBFS), enhance pozzolanic reactions and create additional sites for carbon dioxide capture. Furthermore, the moisture retention properties of the alginate beads create localized high-humidity environments within the concrete, facilitating greater direct air capture of CO₂ throughout the concrete's service life.

This innovative concrete composition not only addresses the carbon emissions associated with concrete production but also actively removes CO₂ from the atmosphere, representing a significant advancement in sustainable construction materials.

This embodiment leverages the synergistic interactions between the alginate beads and other concrete components, including geopolymers, fly ash, and ground granulated blast furnace slag (GGBFS). These interactions enhance pozzolanic reactions, create additional sites for carbon dioxide capture, and prolong the period of CO₂ absorption.

The alginate beads, formed through ionic gelation of brown algae powder, play a crucial role in moisture retention, creating localized high-humidity environments within the concrete that facilitate greater direct air capture of CO₂. This moisture retention is essential for the carbon sequestration process, as it provides a medium for CO₂ to dissolve and react with calcium ions to form stable calcium carbonate.

The formation of stable calcium carbonate through the interaction of dissolved CO₂ with calcium ions contributes to the self-healing of micro-cracks in the concrete, further extending its lifespan and durability. This self-healing property maintains the concrete's ability to absorb CO₂ over a longer period by preserving the integrity of the concrete structure.

By incorporating these innovative features, this embodiment addresses the limitations of previous approaches and provides a concrete composition with superior long-term carbon sequestration capabilities, enabling sustained CO₂ absorption throughout its service life.

An alternative embodiment of the present invention comprises a carbon-sequestering concrete composition with the following components and their respective percentages by mass
Fly Ash (Class F): 22%
Ground Granulated Blast Furnace Slag (GGBFS): 20%
Metakaolin: 4%
Recycled Aggregates: 20%
Natural Aggregates: 12%
Silica Fume: 3%
Sodium Hydroxide (NaOH): 1%
Sodium Silicate (Na₂SiO₃): 2%
Algae Biomass (for Beads): 3%
Calcium Carbonate (CaCO₃): 3%
Magnesium Carbonate (MgCO₃): 3%
Silica from Algae: 1%
Magnesium Silicate: 2%
Olivine (Finely Ground): 3%
Basalt Rock Dust: 2%
Biochar (Activated): 2%
Alginate Beads (Maximized): 3%
Carbonation Accelerators (C—S—H Seeds): 2%
Water: 1%

In this alternative embodiment, the Fly Ash (Class F) content is reduced to 22% in such embodiment to allow for increased CO₂-reactive materials. This adjustment maintains the primary binding function while enhancing the overall carbon sequestration potential of the concrete. The Ground Granulated Blast Furnace Slag (GGBFS) in such embodiment is included at 20%, continuing to enhance strength and durability while acting as a supplementary binder. This component contributes significantly to reducing the carbon footprint associated with concrete production. Metakaolin is reduced to 4% in such embodiment, still improving early strength and reducing permeability while allowing for more CO₂ capture materials. This adjustment contributes to the overall sustainability of the mixture. The ratio of Recycled Aggregates to Natural Aggregates is adjusted to 20% and 12% respectively in accordance with such embodiment. This change further reduces the environmental impact of the concrete production process while maintaining necessary mechanical strength. Silica Fume is increased to 3% to enhance the pore structure, strength, and durability of the concrete. This increase improves the overall performance and CO₂ sequestration potential. The activators, Sodium Hydroxide (NaOH) and Sodium Silicate (Na₂SiO₃), are adjusted to 1% and 2% respectively. This optimization balances the geopolymerization process while minimizing environmental impact. Algae Biomass for beads is increased to 3%, maximizing CO₂ sequestration potential through enhanced alginate bead formation and direct air capture. Both Calcium Carbonate (CaCO₃) and Magnesium Carbonate (MgCO₃) are increased to 3% each in accordance with this embodiment, enhancing carbonation during curing and beyond, thus improving overall CO₂ capture. Magnesium Silicate is increased to 2%, and Olivine (Finely Ground) to 3%, enhancing CO₂ sequestration through increased mineral carbonation potential. Basalt Rock Dust is increased to 2%, providing more trace minerals and enhancing CO₂ uptake through mineral carbonation. Biochar (Activated) is increased to 2%, improving carbon sequestration and internal curing of the concrete. Alginate Beads are included at 3% in accordance with such embodiment, significantly enhancing CO₂ capture and improving the concrete's overall performance. Carbonation Accelerators (C—S—H Seeds) are increased to 2%, further accelerating strength gain and CO₂ uptake during curing. Water content remains at 1%, maintaining the necessary workability and facilitating chemical reactions.

This alternative embodiment demonstrates enhanced carbon sequestration capabilities. For every 1,000 tons of concrete produced, this embodiment creates approximately 64.2 tons of CO₂ but sequesters 101 tons of CO₂ through direct air capture (DAC) and mineralization. This results in a net sequestration of approximately 36.8 tons of CO₂ per 1,000 tons of concrete produced in accordance with an exemplary implementation.

The carbon sequestration in this embodiment occurs through several mechanisms, including biochar absorption, algae biomass uptake, carbonates reaction, mineral carbonation, alginate bead absorption, and CO₂ absorption during curing. The total CO₂ sequestered amounts to 101,000 kg (101 tonnes) per 1,000 tons of concrete produced.

This embodiment leverages the synergistic interactions between the alginate beads and other concrete components, including geopolymers, fly ash, and ground granulated blast furnace slag (GGBFS). These interactions enhance pozzolanic reactions, create additional sites for carbon dioxide capture, and prolong the period of CO₂ absorption.

The alginate beads, formed through ionic gelation of brown algae powder, play a crucial role in moisture retention, creating localized high-humidity environments within the concrete that facilitate greater direct air capture of CO₂. This moisture retention is essential for the carbon sequestration process, as it provides a medium for CO₂ to dissolve and react with calcium ions to form stable calcium carbonate.

The formation of stable calcium carbonate through the interaction of dissolved CO₂ with calcium ions contributes to the self-healing of micro-cracks in the concrete, further extending its lifespan and durability in an embodiment. This self-healing property maintains the concrete's ability to absorb CO₂ over a longer period by preserving the integrity of the concrete structure.

By incorporating these innovative features and optimizing the component ratios, this alternative embodiment addresses the limitations of previous approaches and provides a concrete composition with superior long-term carbon sequestration capabilities, enabling sustained CO₂ absorption throughout its service life.

The carbon-sequestering concrete composition described in the embodiments of the invention in an example is designed to maximize eligibility for significant tax credits and incentives, potentially resulting in substantial cost savings for concrete producers and users. In an example, the tax credits could be allocated for 1,000 tons of concrete produced as an embodiment of the invention in accordance with the following:

Section 45Q tax credits could provide approximately $100,000 to $150,000 in savings per 1,000 tons of concrete produced, depending on the final determination by the EPA/IRS and the results of a Life Cycle Assessment (LCA). This estimate is based on the net carbon sequestration capabilities of the concrete, which ranges from 9.85 to 36.8 tons of CO₂ per 1,000 tons of concrete produced, depending on the specific embodiment.

The Investment Tax Credit could cover up to 30% of a concrete mixer's investment in this carbon-sequestering concrete technology. This credit would apply to the capital expenditures required to implement the new production methods and equipment necessary for manufacturing this innovative concrete.

Additional tax incentives that may be applicable in association with and as an expected benefit of an embodiment of the invention include:

R&D tax credits for the ongoing development and improvement of the carbon-sequestering concrete technology. Production Tax Credits for the manufacture of environmentally beneficial products. Various federal and state tax incentives designed to promote sustainable construction practices and materials.

When considering a larger scale of production, for example 20 medium sized building construction projects, the total savings from these combined tax credits and incentives could exceed $5 million for a concrete producer. This estimate takes into account the cumulative effect of the various tax benefits across multiple projects.

The economic benefits of these tax credits extend beyond mere cost savings. They also enhance the competitiveness of the carbon-sequestering concrete in the market. Before applying any tax credits, the price of this innovative concrete is approximately $138 per ton, which is already competitive with conventional concrete. However, after factoring in the tax credits, the effective price drops to around $112 per ton, making it more economical than conventional concrete options.

In accordance with various embodiments, the exact allocation and amount of tax credits may vary depending on factors such as the specific project details, the concrete producer's financial situation, and any changes in tax laws or regulations. Additionally, the realization of these tax benefits would likely require careful documentation of the carbon sequestration capabilities of the concrete, as well as compliance with relevant regulatory requirements, which is an intended use in accordance with an embodiment of the invention.

Another embodiment of the invention comprises a carbon-sequestering concrete composition optimized for maximum CO2 sequestration and economic viability through tax incentives, as follows:

The composition of this carbon-sequestering concrete in such embodiment is carefully formulated to maximize both CO2 sequestration capabilities and eligibility for tax credits. The mixture, designed for a 1,000-ton batch, comprises several key components that work synergistically to achieve these goals.

Aluminosilicate materials form the foundation of the geopolymer binder system in such embodiment. These include 30% Fly Ash (Class F), 20% Ground Granulated Blast Furnace Slag (GGBFS), 5% Metakaolin, and 3% Silica Fume. These materials not only contribute to the strength and durability of the concrete but also play a crucial role in CO2 sequestration through pozzolanic reactions.

A significant portion of the mix in such embodiment is dedicated to CO2-absorbing materials. This includes 15% Magnesium Silicate, 15% finely ground Olivine, 10% Activated Biochar, 3% Calcium Carbonate (CaCO3), and 2% Magnesium Carbonate (MgCO3). These components are specifically chosen for their high CO2 sequestration potential and their ability to form stable carbonate compounds over time.

The aggregate portion of the mix consists of 10% Natural Aggregates and 5% Recycled Aggregates, balancing structural requirements with sustainability considerations in accordance with such embodiment. The alkaline activators, crucial for the geopolymerization process, include 2% Sodium Hydroxide (NaOH) and 4% Sodium Silicate (Na2SiO3).

A key innovation in this embodiment is the incorporation of algae-derived components. This comprises 1% Silica from Algae, 3% Algae Biomass for bead formation, and 5% Alginate Beads. These components significantly enhance the CO2 sequestration capabilities of the concrete through increased surface area and the creation of localized high-humidity environments that facilitate CO2 absorption.

The mixture in such embodiment also comprises 2% Carbonation Accelerators in the form of C—S—H Seeds, which enhance the rate of CO2 uptake during the curing process. The water content is maintained at 5%, with small amounts of superplasticizers (0.5%) and air-entraining agents (0.1%) added to optimize workability and durability.

The production process of this concrete composition in such embodiment has been observed by the inventor to result in total emissions of 108,550 kg CO2 per 1,000 tons produced. However, the CO2 sequestration capabilities of the mixture are substantial, with a total CO2 sequestration potential of 435,000 kg CO2 per 1,000 tons of concrete. This results in a net negative carbon footprint of −326,450 kg CO2 per 1,000 tons of concrete produced in accordance with inventor observations.

The CO2 sequestration occurs through several mechanisms in accordance with such embodiment. The Magnesium Silicate and Olivine each sequester 45,000 kg CO2. The Activated Biochar contributes significantly with 200,000 kg CO2 sequestered. The Algae Biomass and Alginate Beads together sequester 80,000 kg CO2. The Calcium and Magnesium Carbonates add another 5,000 kg CO2 to the total. Additionally, the CO2 curing process is estimated to sequester an additional 50,000 kg CO2.

This embodiment is designed to maximize eligibility for tax credits, particularly the Section 45Q tax credit for carbon oxide sequestration. For every 1,000 tons of concrete produced, this composition is eligible for approximately $26,100 in Section 45Q tax credits. When combined with other available tax credits such as the Investment Tax Credit and R&D credits, the total tax credits per 1,000 tons could reach approximately $354,100 in accordance with the regulations in place as of September 2024.

The economic viability of this concrete composition in such embodiment is further enhanced by these tax incentives. After accounting for all applicable tax credits, the effective cost of this concrete is estimated to be $57.85 per ton, making it highly competitive in the market.

In comparison to other carbon-reducing concrete technologies, this embodiment demonstrates superior performance. For instance, when compared to Blue Planet's concrete, which sequesters 330 tons CO2 per 1,000 tons of concrete, this embodiment sequesters 435 tons CO2. This results in higher eligibility for Section 45Q tax credits and overall tax credits under applicable regulations in place in September 2024.

The enhanced CO2 sequestration capabilities of this concrete composition in such embodiment are achieved through the synergistic interactions between its components, particularly the alginate beads and other concrete constituents like geopolymers, fly ash, and ground granulated blast furnace slag. These interactions enhance pozzolanic reactions and create additional sites for carbon dioxide capture. The moisture retention properties of the alginate beads create localized high-humidity environments within the concrete, facilitating greater direct air capture of CO2 throughout the concrete's service life.

This innovative concrete composition in accordance with such embodiment not only addresses the carbon emissions associated with concrete production but also actively removes CO2 from the atmosphere, representing a significant advancement in sustainable construction materials. Its superior carbon sequestration capabilities, combined with its economic viability through tax incentives, position it as a potentially disruptive technology in the concrete industry.

The carbon-sequestering concrete composition described in the embodiment can be formulated with varying proportions of its key components to optimize performance and CO2 sequestration capabilities. The aluminosilicate materials, which form the foundation of the geopolymer binder system, can range from 30-60% of the total composition. This range allows for flexibility in adjusting the mix based on specific project requirements and material availability. The CO2-absorbing materials, crucial for the concrete's carbon sequestration properties, can constitute 30-50% of the mixture. This range ensures a significant portion of the concrete is dedicated to active CO2 absorption while maintaining structural integrity.

The aggregate portion, balancing structural requirements with sustainability considerations, can range from 10-20% of the total composition in accordance with such embodiment. The alkaline activators, essential for the geopolymerization process, can comprise 5-10% of the mixture. The innovative algae-derived components, which significantly enhance CO2 sequestration capabilities, can make up 5-15% of the composition. This range allows for optimization of the algae-based materials' contribution to carbon capture. Carbonation accelerators can be included at 1-5% to enhance CO2 uptake during curing, while water content can be maintained between 4-6% to ensure proper workability and hydration.

These ranges have been determined through extensive experimentation and observation by the inventor. They allow for the concrete composition in accordance with such embodiment to sequester at least 400 kg of CO2 per 1,000 kg of concrete produced, achieving a net negative carbon footprint of at least 300 kg CO2 per 1,000 kg of concrete. This flexibility in composition enables the concrete to be tailored for specific applications while maintaining its superior carbon sequestration capabilities and economic viability through tax incentives.

The innovative features incorporated in the preferred embodiment address the limitations of previous approaches and provide a concrete composition with superior carbon sequestration capabilities. The use of brown algae-derived alginate beads, their synergistic interactions with other concrete components, and the enhanced moisture retention properties all contribute to a more effective and long-lasting carbon capture solution. This advanced concrete formulation not only reduces the carbon footprint associated with concrete production but also actively removes CO2 from the atmosphere throughout its service life, representing a significant step forward in sustainable construction materials.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

I claim:

1. A method of producing a carbon-sequestering concrete comprising:
mixing sand and gravel aggregates while dry;
adding and dry blending geopolymer binder components comprising at least one of slag, fly ash class C, fly ash class F, metakaolin, or silica fume;
forming alginate beads by ionic gelation of brown algae powder;
adding the alginate beads to the dry mixture of aggregates and geopolymer binder components;
slowly incorporating water while mixing to achieve a workable concrete consistency; and
pouring the concrete mixture into molds or forms for casting.

2. The method of claim 1, wherein forming the alginate beads comprises:
mixing brown algae powder with water to create an alginate solution;
introducing the alginate solution dropwise into a bath containing calcium ions; and
collecting the formed alginate beads.

3. The method of claim 2, wherein the brown algae powder is derived from Macrocystis pyrifera.

4. The method of claim 1, further comprising controlling the size and density of the alginate beads by adjusting at least one of: concentration of the alginate solution, type and concentration of crosslinking ions, and droplet size.

5. The method of claim 1, further comprising allowing an initial hardening and drying process during which the alginate beads absorb carbon dioxide directly from the air through natural chemical reactions with the geopolymer compounds.

6. A carbon-sequestering concrete composition comprising:
35-50% geopolymers comprising at least one of ground granulated blast furnace slag, class C fly ash, class F fly ash, metakaolin, or silica fume;
30-45% sand;
15-25% coarse aggregates comprising gravel or crushed stone;
5-10% water; and
1-5% alginate beads formed from brown algae powder.

7. The composition of claim 6, wherein the alginate beads are formed through ionic gelation of brown algae powder derived from Macrocystis pyrifera.

8. The composition of claim 6, further comprising at least one of magnesium carbonate and olivine (Mg2SiO4).

9. The composition of claim 6, wherein the alginate beads create a matrix across the surface of the concrete, increasing carbon dioxide absorption surface area compared to algae powder.

10. The composition of claim 6, wherein the alginate beads contribute to self-healing of micro-cracks in the concrete by facilitating ongoing formation of carbonate compounds.

11. A carbon-sequestering concrete composition comprising:
a geopolymer binder;
aggregates;
alginate beads formed from brown algae powder through ionic gelation; and
at least one carbon dioxide sequestration enhancer selected from the group consisting of biochar, calcium carbonate, magnesium carbonate, magnesium silicate, olivine, and basalt rock dust.

12. The carbon-sequestering concrete composition of claim 11, wherein the geopolymer binder comprises at least one of fly ash, ground granulated blast furnace slag, metakaolin, or silica fume.

13. The carbon-sequestering concrete composition of claim 11, wherein the alginate beads are formed from brown algae species Macrocystis pyrifera.

14. The carbon-sequestering concrete composition of claim 11, further comprising carbonation accelerators in the form of calcium silicate hydrate (C—S—H) seeds.

15. A carbon-sequestering concrete composition comprising:
30-60% aluminosilicate materials selected from the group consisting of: fly ash, ground granulated blast furnace slag, metakaolin, and silica fume;
30-50% CO2-absorbing materials selected from the group consisting of: magnesium silicate, olivine, biochar, calcium carbonate, and magnesium carbonate;
10-20% aggregates selected from the group consisting of: natural and recycled aggregates;
5-10% alkaline activators selected from the group consisting of: sodium hydroxide and sodium silicate;
5-15% algae-derived components selected from the group consisting of: silica from algae, algae biomass, and alginate beads;
1-5% carbonation accelerators; and
4-6% water;
wherein the composition is capable of sequestering at least 400 kg of CO2 per 1,000 kg of concrete produced.

16. The carbon-sequestering concrete composition of claim 15, wherein the aluminosilicate materials comprise 30% fly ash (Class F), 20% ground granulated blast furnace slag, 5% metakaolin, and 3% silica fume.

17. The carbon-sequestering concrete composition of claim 15, wherein the CO2-absorbing materials comprise 15% magnesium silicate, 15% finely ground olivine, 10% activated biochar, 3% calcium carbonate, and 2% magnesium carbonate.

18. The carbon-sequestering concrete composition of claim 15, wherein the algae-derived components comprise 1% silica from algae, 3% algae biomass for bead formation, and 5% alginate beads.

19. The carbon-sequestering concrete composition of claim 15, further comprising 0.5% superplasticizers and 0.1% air-entraining agents.

20. The carbon-sequestering concrete composition of claim 15, wherein the composition has a net negative carbon footprint of at least 300 kg CO2 per 1,000 kg of concrete produced.
